(19) United States
(12) Patent Application Publication
(10) Pub. No.: US 2023/0134413 A1
(43) Pub. Date: May 4, 2023

(54) WATER BAG CHECK VALVE

(71) Applicant: LIFTEK FZC, Sharjah (AE)

(72) Inventor: Onur AKIN, Sharjah (AE)

(21) Appl. No.: 17/754,541

(22) PCT Filed: Sep. 2, 2019
(86) PCT No.: PCT/IB2019/000710

§ 371 Date: Apr. 5, 2022

(51) Int. Cl. F16K 31/46; F16K 31/524

(52) U.S. Cl. CPC F16K 31/465; F16K 31/52408

(57) ABSTRACT

A checkbag valve system installed at the bottom of the drainage systems used in sea water, oil tanks, petroleum derivatives and the like to discharge water in water bags which is used for weigh generation to test the lifting capacities of the cranes. A flow preventon plug located at the discharge point of the reservoir is pulled off the hole by a rope or electric actuator to discharge the liquid out or forward the liquid freely to another pipe. The open and close command is provided by a single channel and the opening and closing of the reservoir or low pressure containers is provided with two different commands combined in a way in order to provided a single command from a single point at different times. The risk of rupture of the drive rope mechanism is minimized and there is the reduction in the number of relevant staff for the operation and the maintenance of the valve system. FIG. 4.

### TECHNICAL FIELD

The present invention generally relates to a device of fluid machinery used for the guiding of fluid through different passages and particularly relates to valve systems. More specifically the present invention relates to the check valve systems located at the bottom and used as a discharge system in liquid filled tanks or in reservoirs.

### BACKGROUND

The check valves are generally employed for guiding the flow of fluid in any kind system and a number of check valves are employed for this purpose such as ball check valve, diaphragm check valve, swing check valve, flapper valve, stop check valve, lift check valve, in-line check valve, a pneumatic non-return valve and the like. Check valves are often used with some type of pumps and a multiple number of check valves can be connected in series. A general function of the check valves is to prevent back flow and in case of drainage system where check valves are employed, the function of the valve is the backflow prevention and keeping the potentially contaminated water from siphoning back into municipal water supply lines. Piston-driven and diaphragm pumps like metering pumps and the pumps for chromatography commonly use inlet and outlet ball check valves. These valves often look like small cylinders attached to the pump head on the inlet and outlet lines. A ball check valve is used with pump-like mechanism to move volume of fluids around. The check valves are also used in the pumps to supply or guide water to water slides. The water to the slide flows through a pipe which doubles as the tower holds the steps to the slide and if the slide is closed for the night, the check valve stops the flow of water through the pipe.

Different classes of check valves are used for different type of operation to be performed. A butterfly check valve is another class of check valves having an operation mechanism similar to that of the ball check valves which allows for quick shut off. Butterfly valves are generally favored as they cost less than the other kind of valve designs and are lighter in weight, hence need less support. The mechanism of the butterfly valves is that a disc is positioned in the centre of the pipe and a rod is passed through the disc to an actuator on the outside of the valve. When the actuator is rotated the disc turns either parallel or perpendicular to the flow. Unlike the ball check valve, the disc is always present in the pipe so as to induce some pressure drop even when it is open. The butterfly valve is from the family of valves called as quarter-turn valves. The operating principle of these check valves is that the valve is fully opened or closed when the disc is rotated a quarter turn. The name butterfly signifies a metal disc mounted on a rod and when the disc is turned for the valve closure it completely blocks off the passageway and when the disc is turned a quarter turn the valve is opened so that it allows unrestricted passage of the fluid to pass. The valve may also be opened incrementally by employing the throttling principle or throttle flow. Different kind of butterfly check valves are used with each one of them adapted for different pressure and different usage. A zero-offset butterfly valve uses the flexibility of rubber and has the lowest pressure rating. The high performance double offset butterfly valve uses slightly high pressure systems is generally offset from the centre line of the disc seat and body seal and the centre line of the bore. This creates a cam action during operation to lift the seat out of the seal resulting in less friction than is created in the zero offset design and decreases its tendency to wear. The valve best suited for high-pressure systems is the triple offset butterfly valve. In this valve the disc seat contact axis is offset, which acts to virtually eliminate sliding contact between disc and seat. In the case of triple offset valves the seat is made of metal so that it can be machined such as to achieve a bubble tight shut-off when in contact with the disc. Various butterfly valves are employed for different purposes such as concentric butterfly valves having a resilient rubber seat with a metal disc, double-eccentric butterfly valves or high-performance butterfly valves or double-offset butterfly valves employs different materials for seat and disc and triply-eccentric butterfly valves wherein the seats are laminated or are solid metal seat design.

The check valves are installed at different locations in a system depending upon the usage to be employed therein. The check valves are used in drainage systems in sea water, water and oil tanks, petroleum derivatives, food water and refinery systems. These check valves are also installed at the bottom of the tanks or reservoirs or any other enclosure therein and the function of these valves specifically butterfly check valves or waterbag check valves is to discharge liquid from the tanks and reservoirs. The check valves with a disc performs or have principle of operation and mechanism differently from other check valves and as already mentioned above, the butterfly check valves with a disc performs by means of an actuator. A number of valves have been developed which are being installed at the discharge points of the reservoirs as in the present invention.

The drainage system is one of the most important systems to expel or discharge the fluid. In the present invention a check valve installed at the bottom of the system in addition of the discharging fluid also expels air from the air filled solid or flexible tanks or reservoirs. This is generally the case of lifting of balloons used under the sea in the submerged extraction works.

The present invention solves the problem of drainage water, sea water, oil tanks and reservoirs, and the like by employing waterbags which are used for weight generation and the weights which are generated are employed to test the lifting capabilities of the cranes. The present invention also solves the problem to expel air from the air filled solid and flexible tanks or reservoirs. Generally this problem is encountered in the submerged extraction works and is eliminated usually by lifting balloons under the sea during submerged extraction.

The check valve system employed in the oil or water tanks or reservoirs underneath the sea or in drainage systems a cylindrical or butterfly or a flow prevention plug located at the discharge point of the said reservoirs is pulled off the hole by a rope or any electric actuator to discharge the liquid out or forward the liquid freely to another pipe. The existing system are controlled by the on and off technique in the binary command system, hence it needs to be created in two different ways.

In one of the closest prior art CN′20′2218 a backflow prevention device with a controllable flow is disclosed. The device comprises an inflow stopping check valve, a water escape valve and an outflow check valve. The inflow stopping check valve is fixedly connected with the outflow check valve through threads, and the water escape valve is arranged on the lower portion of the inflow stopping check valve. A valve actuator is installed above a valve rod of the inflow stopping check valve, the valve rod of the inflow stopping check valve is movably connected with an inflow stopping check valve plate, opening and closing of the inflow stopping check valve plate can be controlled through a rotating hand wheel, and opening degree of the inflow stopping check valve plate can be adjusted. The water escape valve is composed of a sealing gasket, a base plate, a membrane, a press ring, an adapter sleeve and a lower valve seat. A control chamber is formed, a hole is arranged on the lower portion of a valve body of the inflow stopping check valve to be directly communicated with an upper cavity of the control chamber of the water escape valve, and a water escape opening on the lower portion of the lower valve seat is communicated with the air. The back flow preventing device has the advantages of being capable of controlling water outflow, ensuring matching of the flow and downstream water consumption and effectively preventing frequent water escape caused by pressure fluctuation. A special water escape valve structure ensures that water escapes smoothly.

Although the above mentioned device has some advantages but these kinds of valves cannot be installed at the bottom of the drainage system, where there is a pressure head on the valves is at an alarming rate. Furthermore, the tension of the valve rod escalates due to the pressure head and might result in the failure of the operation of the valve actuator and hence cannot prevent flow escape and needs personals to fix the failure.

In another prior art KR′10′0909, a backflow prevention type butterfly valve is disclosed. The opening and closing portion of the main body with perforated through holes from one end to another end and the rotation is disposed in the body by opening and closing of the through holes. A check valve is provided for opening and closing the through hole by rotating the opening and closing portion at which the fluid at one of the main flow due to the pressure of the fluid portion of the check valve opens. The flow at the other end of the main body when the back pressure is generated the check valve is closed to prevent the reverse flow of the fluid. The flow path of the fluid can be turned on and off at the same time, so as to be able to perform checking function for the backflow prevention of the fluid.

In one of the closest prior art US′9085 which mentions a crane having hydraulic means for boom elevation control which is provided with a load-holding check valve and a float valve interposed there between. The float valve is intentionally operable to a float position establishing fluid communication between opposed actuating chambers of the hydraulic means during crane transportation. The float valve includes a preferred position which does not interfere with conventional operation of combination of the hydraulic means and the load holding valve. The float valve is intentionally actuated to the float position by manually connecting a releasable coupling to a pilot pressure source. During crane operation, the releasable coupling is connected to a discharge hydraulic circuit that disables the float valve to prevent its inadvertent operation. The float valve is operable during crane transportation to allow the boom to move vertically in response to perturbations of a boom supporting dolly.

The prior art mentioned above provides a load holding check valve and a float valve interposed between them. However it does not prevent the back pressure created by the fluid flow. Furthermore, the lifting capacity of the cranes as above mentioned does not employ the water which is discharged to generate weight. The path for lifting the weight in the above mentioned crane operation does not follow a clear path and the load holding valve does not prevent the large quantity of the fluid pressure to flow back.

The butterfly valve has an advantage of opening and closure at the same time, but not in a single command. The above mentioned valve cannot be installed for drainage systems especially under the sea in submerged extraction as the valves cannot with stand under high pressure heads and in case if any failure occurs there is no backflow prevention of the fluid escape.

The present invention offers solution to all the above mentioned limitations of the current check valve systems by locating a cylindrical butterfly or a flow prevention plug at the discharge point of the reservoir. In the conventional valve systems the open and closure of the valve is provided by a single channel. The objective of the present invention is to provide the opening and closing of the reservoirs or low pressure containers by two different commands from a single point at different times.

### SUMMARY OF THE INVENTION

The present invention relates to check valve systems installed at the bottom of the flexible or hard reservoir in order to discharge or expel the fluid and the air from the flexible or solid reservoirs or tanks.

In one of the preferred embodiment of the invention a valve system for drainage employed in sea water, oil tanks, petroleum derivatives and other refinery systems with low pressure reservoir. A check valve installed at a discharge of a flexible or hard filled reservoir surface containing a liquid, the check valve comprises an upper flange joined to a foot. A ball bearing mounted on upper leg of the check valve with a teflon bushing placed in the bearing. A spring passed around a camshaft and below which a sealing washer, a sealing gasket, a seal washer and a lower special working bolt are stacked and mounted respectively. The camshaft is mounted onto the eyebolt and engages the camshaft with a bearing and a cam pin to engage a cam bearing. A lower flange gasket is inserted into the hard filled reservoir through holes being drilled onto the bottom of the flexible or hard filled reservoir. A drive rope or a release mechanism with one end being attached to the check valve through an eyebolt and the other end of the drive rope removed out of the flexible or hard filled reservoir. The drive rope is connected to an actuator and the liquid in the reservoir is displaced as the drive rope is tensioned and the camshaft being specially machined and calculated to ensure that the check valve is kept in different position each time when the drive rope is tensioned. The cam pin placed on the cam bearing follows a path where each traction is followed by open, closed position of the traction in order respectively.

In another preferred embodiment of the invention the release mechanism has two stops which are activated at different times by employing the same command for both the movements. The camshaft has a specific path with two stopping points and in a single command opens and closes the check valves with a first command being a closed command and a second command being an open command. The camshaft and the cam pin guiding the camshaft eliminate the tension of drive mechanism in the flexible or hard filled reservoir. In another embodiment of the invention a flow prevention plug or a lower plug is located at the discharge point of the hard filled reservoir is pulled off the hole by the actuator through the drive pulley to discharge the liquid out or forward the liquid freely to another pipe and this cycle is repeated as many times as a practitioner wishes and concludes as desired.

In another preferred embodiment of the invention opening and closing command of the flexible or hard filled reservoir or low pressure container is provided by a single channel with two different commands from a single point at different times. A flow prevention plug or a lower plug located at the discharge point of the hard filled reservoir is pulled off the hole by the actuator through the drive pulley to discharge the liquid out or forward the liquid freely to another pipe. This cycle is repeated as many times as a practitioner wishes and concludes as desired.

In another embodiment of the invention two commands are combined in one command which are applied for at different times as the camshaft and the cam pin leads to two stops, the first is the closed command and the other one is the open command.

In another embodiment of the invention the cylindrical butterfly or a flow preventon plug is located at the discharge point of the reservoir and is pulled off the hole by a rope or electric actuator to discharge the liquid out or forward the liquid freely to another pipe. The open and close command in the present invention is provided by a single channel with two different commands from a single point at different times by the action of the cam on the centre shaft.

In another embodiment of the invention the opening and closing of the reservoir or low pressure containers is provided with two different commands from a single point at different times.

In another preferred embodiment of the invention the camshaft shape has a specific path and has two stopping points and the release mechanism has two stops which can be activated at different times by same command for two movements.

In another embodiment of the invention the cycle is repeated as many times as the practitioner wishes and concludes as desired.

In another preferred embodiment of the invention the check valve systems operates without any problem in a single command consecutively to open and close the valve. The special spindle on the machined cam path and the guiding cam pin work to eliminate the tension in the drive mechanism in flexible reservoirs or low pressure containers. The risk of rupture of the drive or release rope or the wire mechanism is minimized and there is the reduction in the number of relevant staff for the operation and the maintenance of the valve system.

### BRIEF DESCRIPTION OF THE DRAWINGS

The embodiments herein will be better understood from the following detailed description with reference to the drawings, in which:

FIG. 1 illustrates the position of the check valve in the reservoir.

FIG. 2 illustrates a three-dimensional view of the check valve in the reservoir.

FIGS. 3a and 3b illustrates the position of the check valve in an open and closed position respectively.

FIG. 4 illustrates an exploded view of the check valve.

FIG. 5 illustrates an isometric view of the camshaft.

FIG. 6 illustrates a sectional view of the camshaft as mentioned in the FIG. 5.

FIG. 7 illustrates the top view of the camshaft of FIG. 5.

FIG. 8 illustrates the bottom view of the camshaft of FIG. 5.

### DETAILED DESCRIPTION OF THE INVENTION

The embodiments herein and the various features and advantageous details thereof are explained more fully with reference to the non-limiting embodiments that are illustrated in the following detailed description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The check valve system employed in the oil or water tanks or reservoirs underneath the sea or in drainage systems a cylindrical or butterfly or a flow prevention plug located at the discharge point of the said reservoirs is pulled off the hole by a rope or any electric actuator to discharge the liquid out or forward the liquid freely to another pipe. In the present valve systems, the open and close command is provided by the single channel. The valve system provides opening and closing of the reservoir or the low pressure container with two different commands from a single point at different times.

The present invention provides a solution during the release mechanism of the discharged fluid through the valve system, the breakdown does not cause any fluid to be discharged unintentionally, rather the valve is closed, unlike other systems where a staff or a particular technical member is to be assigned to each of the tanks and any negligence that may occur will damage the system. The present invention reduces the task by reducing the number of experts and hence reducing the risk.

When employing the present check valve system, by pulling with a rope or wire from the above by the action of the cam on the centre shaft which is specially calculated and machined. It should be ensured that the valve is kept at different positions each time when the rope or wire is pulled. The cam pin which is placed on the cam bearing is provided to follow the path and each traction is followed by the open and closed position of the traction in order such as, when the rope along the traction or path is pulled, it is an open position, then when left it is an off position. Each time when the rope is pulled, the valve is opened and when the rope or wire is left, the valve is closed. The position of the valve to be open and close remains above and below as per the position of the rope along the path of the cam pin and the cam bearings. For example when it is above, it is open and when it is below it is closed. This command is reversed when the valve is used in reverse.

When the valve is released by pulling up the rope or wire, there is no need for the user to keep the release mechanism taut as to keep the valve system open or closed throughout the application. For the user it is very easy and flexible not to keep the valve closed or open throughout the operation in flexible tanks. The mechanism works like this when there is to discharge of the reservoir in the flexible tanks, the rope or wire is pulled and the surfaces of the fluid are displaced allowing the rope or the wire to be tensioned or discharged on the drive mechanism. In case of the release mechanism, when the wire or the rope is broken, the discharged rope valve causes the unintentional command to be closed, that is the valve is automatically closed.

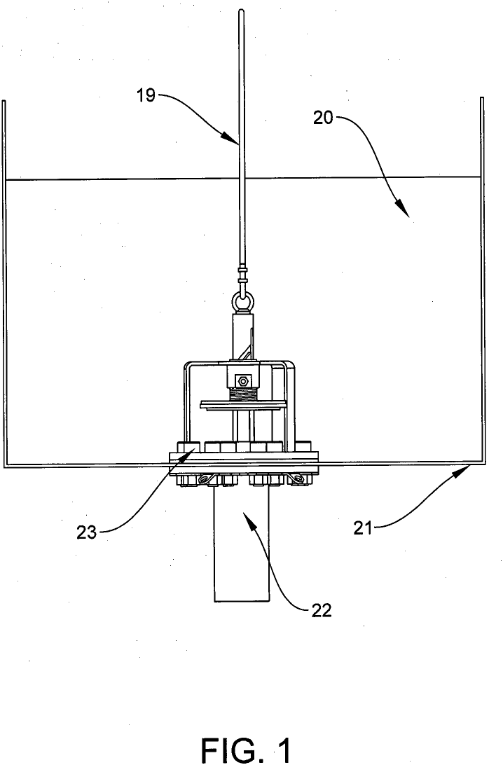

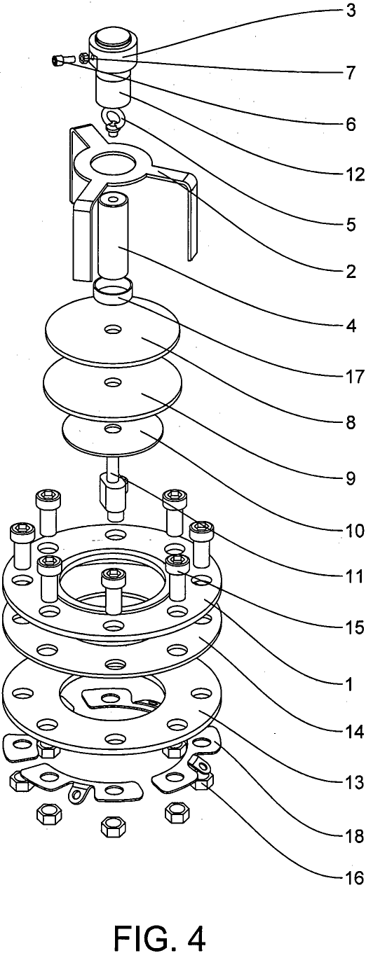

FIG. 1 shows the position of the check valve in the reservoir. A check valve (23) is installed at the bottom of the reservoir surface (21) which may be flexible or hard filled and a drive rope (19) is connected to the check valve (23) through the eyebolt (5) of the camshaft (4) (from FIG. 4). The position of the check valve shown is in open position as the flanges are up and the fluid is discharged (22) from the liquid (20) in the reservoir (21). The drive rope is tensioned through the liquid as the surface of the liquid (20) is displaced. Also when the drive rope (19) is tensioned, the air is expelled from the air filled or liquid filled hard or flexible tanks.

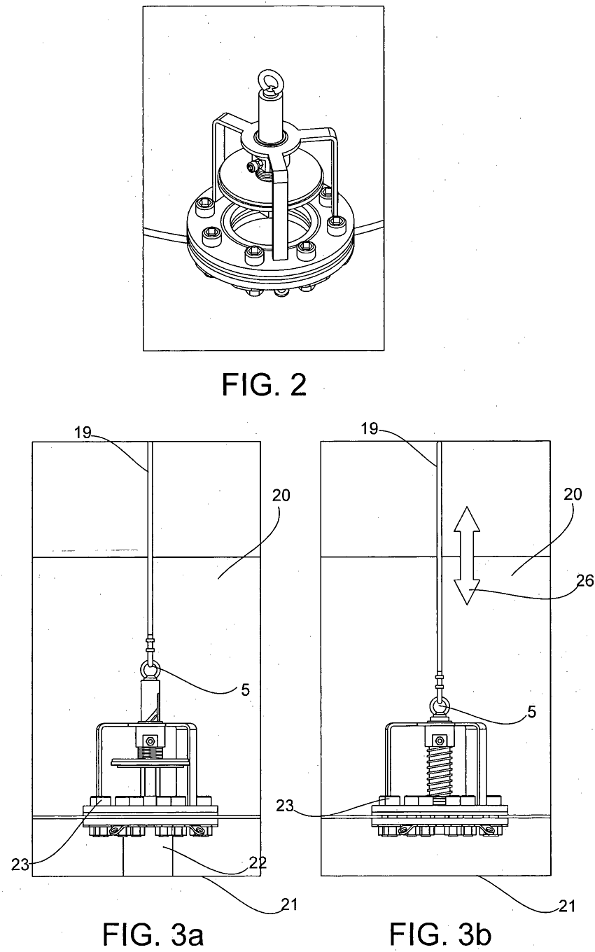

FIG. 2 illustrates an isometric or three dimensional view of the check valve in the reservoir and FIG. 4 displays all the components of the valve system in an exploded view. An upper flange (1) is connected to a bottom flange (13) with a flange gasket (14) and to a butterfly rope connection (18) by using mounting bolts (15) on the top and the mounting nuts (16) at the bottom of the check valve. A foot (2) with multiple supports and an annular hole through which the camshaft (4) is connected to the shaft bearing (3). The shaft bearing (3) has a nut (7) to which the cam pin (6) is attached and a Teflon bushing (12) is provided to the shaft bearing (3) below which is the rope eyebolt (5) to which the drive rope (19) is connected. The camshaft (4) is connected to the bearing shaft (3) to which the drive rope (19) is connected and a pressure spring (17) is connected to the lower bolt (11) through a closure stamp (8), a sealing gasket (9) and a gasket washer (10).

The upper flanges (1) is joined to the foot (2) and mount the ball bearing or the bearing shaft (3) on the upper leg. The Teflon bushing (12) is placed in the bearing to mount the special camshaft (4) onto the eyebolt (5) and engage it with the bearing and cam pin (6) to engage the cam bearing and the pressure spring (17) is passed around the cam shaft. The sealing washer (8), the sealing gasket (9), the seal washer (10) and the lower special working bolt (11) are co-axially arranged and mounted respectively. As the upper group is completed, the lower flange gasket (14) is inserted into the solid tank or through holes drilled into the flexible tank. After fixing the lower plug (13) and the butterfly connection (18), it is fixed with the mounting equipment.

FIGS. 3a and 3b disclose the mechanism or the operating principle of the check valve system installed in the reservoir. The check valve is installed at the bottom of the flexible or solid reservoir and a space is drilled or machined at the bottom of the reservoir for the check valve. The drive rope or steel wire (19) is fixed to the upper eyebolt (5) and the other end of the rope or wire is removed or taken out of the liquid tank or reservoir. When the rope or the wire is stretched or tensioned the liquid in the reservoir or tank gets displaced and as the pulling action of the rope is continued the camshaft (4) is pulled out of the along with the sealing washer (8) and the open command of the check valve is activated. The fluid from the flexible or solid tank or reservoir is spilled out. When the rope is released, the traction or path of the camshaft is back to the initial position. The camshaft moves back through the annular hole of the foot (2) and the upper and lower flanges. The closed command is activated when the camshaft is retracted back to the initial position. It is often desired that if the drive rope (19) is cut or tore out during the open command of the valve, the closed command is automatically activated as the camshaft (4) is retraced back to the valve system and there is no loss of the fluid from the reservoir. The camshaft (4) and the cam pin (6) leads to two stops or commands with the first command to be the closed command as shown in FIGS. 3 (a & b) and the second command is the open command and opens when the cam pin (6) is pulled or stretched along the traction of the camshaft (4). The release mechanism has two stops which are activated at different times by the same command for two movements and the cycle can be repeated as many times as the practitioner wishes and concludes as is required or desired.

The check valve operates like that when the drive rope (19) as shown in FIG. 3b is stretched or tensioned manually or by some actuator outside the reservoir (21) the liquid is displaced and the drive rope (19) is pulled off the foot (2) and follows along the path (26). The valve is opened by pulling off the drive rope (19) as shown in FIG. 3a as the closure stamp (8) is above. The user does not need to keep the release mechanism or the drive rope (19) stretched during the operation. This makes the check valve easier to operate for the user in flexible tanks. During the discharge of fluid from the reservoir (21) the surfaces are displaced and the release mechanism or wire may be broken, the discharged rope valve causes the unintentional command to be closed.

FIG. 4 as mentioned earlier illustrates an exploded view of the check valve system which is to be installed at the bottom of the flexible or solid reservoir or tank. All the components of the check valve which function relative of one another are disclosed. The functionality of the components displayed is mentioned above. The sealing washer (8), the sealing gasket (9), the seal washer (10) and the lower special working bolt (11) are provided in order to prevent backflow and completely seal the fluid in the reservoir or tank from spilling out without any kind of command given to the valve system.

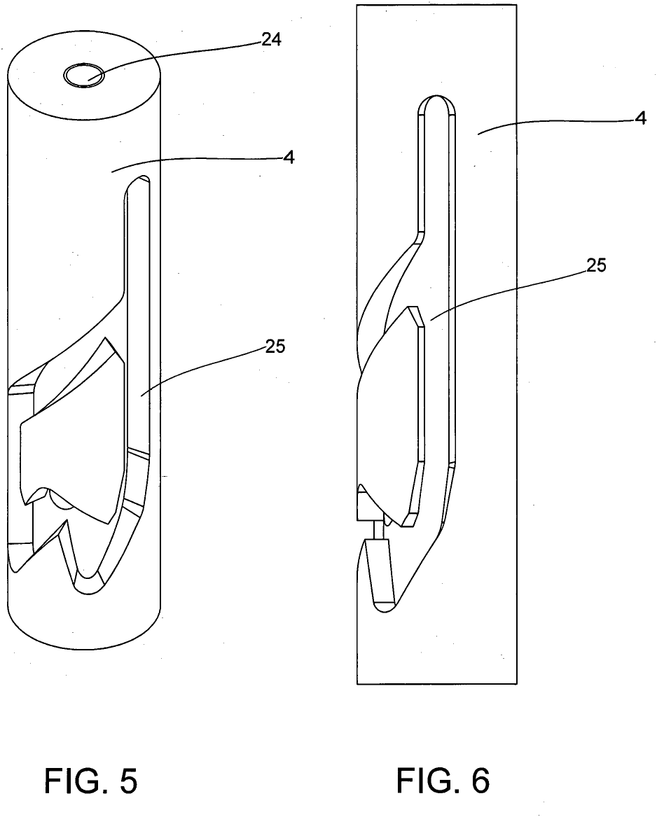

FIG. 5 illustrates an isometric view of the camshaft (4) installed at the upper portion of the check valve. The camshaft (4) is specially calculated and machined for the purpose of opening and closing of the valve. The drive rope (19) which is connected to the eyebolt (5) through the cam pin (6) is attached to the camshaft (4) for pulling and releasing action along the traction followed by the camshaft (4). A through hole (24) is machined in order to be attached to the working bolt (11) on the lower section of the check valve as shown in FIG. 4 through the sealing elements. The machined section (25) of the camshaft (4) as shown in FIG. 5, is passed around by the spring (17) which allows the pulling off and pulling on of the check valve.

FIG. 6 illustrates a sectional view of the camshaft (4) as mentioned earlier. The dimensions of the camshaft (4) varies according to the application of the valve, whether the valve is used for fluid discharging, for testing the lifting of cranes, and any of the purposes wherein a check valve or a valve is needed. The length of the check valve herein employed is not less than 149 units and may vary accordingly. The machined section (25) of the camshaft provides a locking function to the valve and prevents the backpressure and backflow of the fluid.

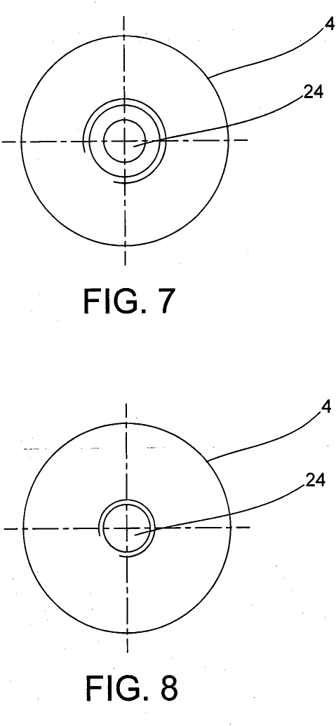

FIGS. 7 and 8 illustrates the top and the bottom view of the camshaft (4). As mentioned earlier the dimensions of the camshaft vary according to the application. The external diameter of the camshaft (4) is generally three times the internal diameter of the through hole (24). The outer diameter of the through hole (24) which is formed like an annular ring is not less than the twice the diameter of internal annular hole. The bottom view also displays an annular section of the through hole (24) with varying diameters.

The check valve system as explained above can be manufactured or produced in the industry as any other valve systems. The check valve system of the present invention is not limited to the examples mentioned herein. The shape, size and other dimensions can be varied according to the application and the requirement as desired.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms mentioned.

What is claimed is:

1. A valve system for drainage employed in sea water, oil tanks, petroleum derivatives and other refinery systems with low pressure reservoir, the system comprising:
a check valve installed at a discharge of a flexible or hard filled reservoir surface containing a liquid, the check valve comprises:
an upper flange joined to a foot;
a ball bearing mounted on upper leg of the check valve with a teflon bushing placed in the bearing;
a spring passed around a camshaft and below which a sealing washer, a sealing gasket, a seal washer and a lower special working bolt are stacked and mounted respectively;
the camshaft is mounted onto the eyebolt and engage the camshaft with a bearing and a cam pin to engage a cam bearing;
a lower flange gasket is inserted into the hard filled reservoir through holes being drilled onto the bottom of the flexible or hard filled reservoir;
a drive rope or a release mechanism with one end being attached to the check valve through an eyebolt and the other end of the drive rope removed out of the flexible or hard filled reservoir;
the drive rope is connected to an actuator and the liquid in the reservoir is displaced as the drive rope is tensioned, wherein
the camshaft being specially machined and calculated to ensure that the check valve is kept in different position each time when the drive rope is tensioned; and
the cam pin placed on the cam bearing follows a path where each traction is followed by open, closed position of the traction in order respectively.

2. The system as claimed in claim 1, wherein the valve is kept in different positions each time when the drive rope is pulled.

3. The system as claimed in claim 1, wherein the position of the valve depends on the position of the camshaft.

4. The system as claimed in claim 1, wherein when the camshaft is above, the valve is open and when the camshaft is below, the valve is closed.

5. The system as claimed in claim 1, wherein the camshaft shape has a specific path and has two stopping points.

6. A valve system for drainage employed in sea water, oil tanks, petroleum derivatives and other refinery systems with low pressure reservoir, the system comprising:
a check valve installed at a discharge of a flexible or hard filled reservoir surface containing a liquid, the check valve comprises:
an upper flange joined to a foot;
a ball bearing mounted on upper leg of the check valve with a teflon bushing placed in the bearing;
a spring passed around a camshaft and below which a sealing washer, a sealing gasket, a seal washer and a lower special working bolt are stacked and mounted respectively;
the camshaft is mounted onto the eyebolt and engage the camshaft with a bearing and a cam pin to engage a cam bearing;
a lower flange gasket is inserted into the hard filled reservoir through holes being drilled onto the bottom of the flexible or hard filled reservoir;
a drive rope or a release mechanism with one end being attached to the check valve through an eyebolt and the other end of the drive rope removed out of the flexible or hard filled reservoir;
the drive rope is connected to an actuator and the liquid in the reservoir is displaced as the drive rope is tensioned, wherein
the release mechanism has two stops which are activated at different times by employing the same command for both the movements;
the camshaft has a specific path with two stopping points and in a single command opens and closes the check valve with a first command being a closed command and a second command being an open command; and
the camshaft and the cam pin guiding the camshaft eliminates the tension of drive mechanism in the flexiable or hard filled reservoir.

7. The system as claimed in claim 6, wherein the command for openeing and closing of the valve is reversed, when the valve is used in reverse.

8. The system as claimed in claim 6, wherein the drive rope is manually streched or tensioned outside the reservoir.

9. The system as claimed in claim 6, wherein the drive rope is strectched or tensioned by actuators on the outside of the reservoir.

10. The system as claimed in claim 6, wherein a steel wire is also used as the drive rope or drive mechanism and fixed to the eyebolt on the upper portion of the check valve.

11. A valve system for drainage employed in sea water, oil tanks, petroleum derivatives and other refinery systems with low pressure reservoir, the system comprising:
a check valve installed at a discharge of a flexible or hard filled reservoir surface containing a liquid, the check valve comprises:
an upper flange joined to a foot;
a ball bearing mounted on upper leg of the check valve with a teflon bushing placed in the bearing;
a spring passed around a camshaft and below which a sealing washer, a sealing gasket, a seal washer and a lower special working bolt are stacked and mounted respectively;
the camshaft is mounted onto the eyebolt and engage the camshaft with a bearing and a cam pin to engage a cam bearing;
a lower flange gasket is inserted into the hard filled reservoir through holes being drilled onto the bottom of the flexible or hard filled reservoir;
a drive rope or a release mechanism with one end being attached to the check valve through an eyebolt and the other end of the drive rope removed out of the flexible or hard filled reservoir;
the drive rope is connected to an actuator and the liquid in the reservoir is displaced as the drive rope is tensioned, wherein
opening and closing command of the flexible or hard filled reservoir or low pressure container is provided by a single channel with two different commands from a single point at different times;
a flow prevention plug or a lower plug located at the discharge point of the hard filled reservoir is pulled off the hole by the actuator through the drive pulley to discharge the liquid out or forward the liquid freely to another pipe; and
this cycle is repeated as many times as a practitioner wishes and concludes as desired.

12. The system as claimed in claim 11, wherein the check valve installed at the discharge of the liquid reservoir is a cylindrical butterfly valve.

13. The system as claimed in claim 11, wherein the check valve comprises of an upper group and a lower group.

14. The system as claimed in claim 11, wherein a limited number of persons operate the required operation of the check valve system.

15. The system as claimed in claim 11, wherein there is minimum risk of rupture of the release mechanism or the drive rope.

16. The system as claimed in claim 11, wherein the camshaft is specially calculated and machined for the required operation of the check valve system.

17. A camshaft for a valve system comprises:
a camshaft and a cam pin attached to the valve system for opening and closing of a valve;
the camshaft is mounted onto an eyebolt which engage the camshaft with a bearing;
the cam pin to engage a cam bearing, wherein
the camshaft is specially machined and calculated to ensure that the valve is kept in different position each time when the drive rope is tensioned or stretched; and
the cam pin placed on the cam bearing follows a path where each traction is followed by open, closed position of the traction in order respectively.
